(19) United States
(12) Patent Application Publication
(10) Pub. No.: US 2015/0379548 A1
(43) Pub. Date: Dec. 31, 2015

(54) Method and System for Data Processing

(71) Applicant: Alibaba Group Holding Limited, Grand Cayman (KY)

(72) Inventor: Chaojun Zhang, Hangzhou (CN)

(21) Appl. No.: 14/752,557

(22) Filed: Jun. 26, 2015

(30) Foreign Application Priority Data
Jun. 30, 2014 (CN) 201410306802.5

(51) Int. Cl. G06Q 30/02

(52) U.S. Cl. CPC G06Q 30/0225; G06Q 30/0212

(57) ABSTRACT

Methods and systems for data processing. The method includes receiving, by a computing device, data to be processed. The computing device may determine whether a random value corresponding to the data to be processed is stored in a storage medium associated with the computing device. If the random value is stored in the storage medium associated with the computing device, the computing device may process the data to be processed using the random value. If the random value is not stored in the storage medium associated with the computing device, the computing device may obtain an additional random value for the data to be processed, and process the data to be processed using the additional random value, and store the additional random value in the storage medium associated with the computing device.

### CROSS REFERENCE TO RELATED PATENT APPLICATIONS

This application claims priority to Chinese Patent Application No. 201410306802.5, filed on Jun. 30, 2014, entitled “Data Processing Method and Apparatus,” which is hereby incorporated by reference in its entirety.

### TECHNICAL FIELD

The present disclosure relates to computer technology, and more specifically to methods and systems for data processing.

### BACKGROUND

With the development of computer technology, a randomly generated value and subsequent actions based on the random values have been widely used in various fields. For example, to process data, a computing device may first obtain a corresponding random value based on the data, and then process the data.

An example illustrating the process above is provided below.

Suppose that there are three discount amounts (e.g., random values), which are provided to a user as promotions. The discount amounts are 10, 20, and 50 yuan, respectively. These discount amounts are available for qualified orders. A client terminal associated with a promotion management system may transmit a payment request to the promotion management system via a payment system, and the payment request may include order data. The promotion management system randomly selects a preset random value among three discount amounts as the random value corresponding to the data to be processed. The promotion management system processes the order using one discount amount.

Suppose that the order amount is 100 Yuan. After the promotion management system receives an order request of order A, the promotion management system randomly selects a discount amount (e.g., 20 Yuan) as the random value. The promotion management system processes the order using one discount amount and determines that the actual amount is 80 Yuan.

If the order fails, the user may resend the order request. In some cases, the user may purposefully cause multiple payments failed and send multiple order requests for the same order to obtain an ideal discount amount. After the promotion management system receives another order request of the order, the promotion management system will randomly select a discount amount as the random value. The promotion management system processes the order using one discount amount and determines the actual amount.

Suppose that the order fails again and the user resends the order request to the promotion management system. The promotion management system selects randomly a discount amount of order A. The promotion management system may obtain the discount amount of 50 Yuan from the order data, and use the discount amount of the random value corresponding to order A. The promotion management system processes the order using one discount amount and determines that the actual amount is 50 Yuan.

Accordingly, after receiving multiple order requests for the same order, the promotion management system may select different random values for the same order. This causes high server load and wastes system resources.

### SUMMARY

Implementations of the present disclosure relate to methods and systems for data processing, and solve high server loads and system resource wasting associated with conventional techniques. This Summary is not intended to identify all key features or essential features of the claimed subject matter, nor is it intended to be used alone as an aid in determining the scope of the claimed subject matter.

A method for data processing may include receiving, by a computing device, data to be processed. The computing device may determine whether a random value corresponding to the data to be processed is stored in a storage medium associated with the computing device. In response to a determination that the random value corresponding to the data to be processed is stored, the computing device may process the data to be processed using the random value. In response to a determination that the random value corresponding to the data to be processed is not stored, the computing device may obtain an additional random value based on the data to be processed, process the data to be processed using the additional random value, and store the additional random value in the storage medium associated with the computing device.

A computing system for data processing may include a receiving module configured to receive data to be processed, a query module configured to determine whether a random value corresponding to the data to be processed is stored in a storage medium associated with the computing system, a processing module configured to process the data to be processed using the random value in response to a determination that a random value corresponding to the data to be processed is stored in the storage medium associated with the computing system. In response to a determination that a random value corresponding to the data to be processed is not stored in the storage medium associated with the computing system, the processing module may obtain an additional random value for the data to be processed, and process the data to be processed using the additional random value, and store the additional random value in the storage medium associated with the computing system.

Implementations of the present disclosure relate to methods and systems for data processing. After receiving data to be processed, a server may determine whether the random value corresponding to the order data is stored in a storage medium associated with the server. In response to a determination that a random value corresponding to the data to be processed is stored in the storage medium associated with the server, the server may process the data to be processed using the random value. In response to a determination that a random value corresponding to the data to be processed is not stored in the storage medium associated with the server, the server may obtain an additional random value, and process the data to be processed using the additional random value. The server may store the additional random value in the storage medium associated with the server. Because the random value is stored in the storage medium associated with the server, when receiving the data to be processed, the server determines that the random value corresponding to the order data is stored and process the data to be processed using the stored random value. In these instances, the server may process the data to be processed without re-obtaining a random value. This effectively reduces server load and saves system resources.

### BRIEF DESCRIPTION OF THE DRAWINGS

The Detailed Description is described with reference to the accompanying figures. The use of the same reference numbers in different figures indicates similar or identical items.

FIG. 1 is a flow chart of an illustrative process for processing data.

FIG. 2 is a schematic diagram of an illustrative computing environment that enables data processing using a promotion management system.

FIG. 3 is a flow chart of an illustrative process for process data in a scenario of promotions.

FIG. 4 is a schematic diagram of an illustrative computing architecture that enables data processing.

### DETAILED DESCRIPTION

The present disclosure may be implemented in many ways other than those described herein, and those skilled in the art may make similar promotion without departing from the present disclosure. Therefore, the present disclosure is not limited to the particular implementations described below.

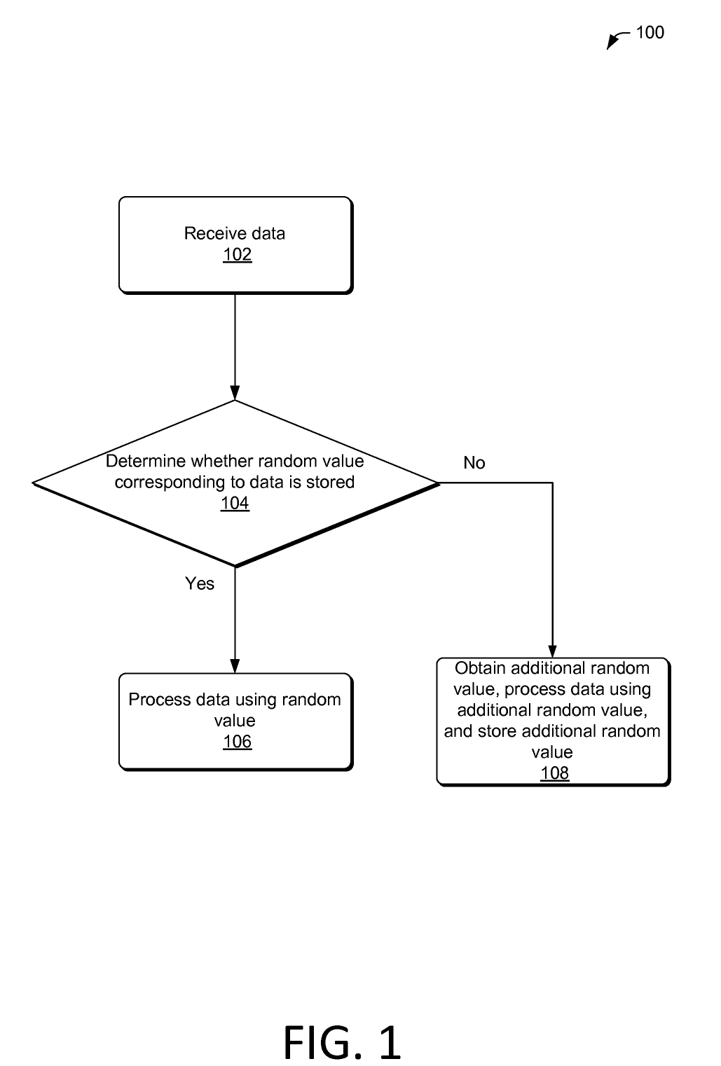

FIG. 1 is a flow chart of an illustrative process 100 for processing data. At 102, a server may receive data to be processed. In implementations, a client terminal may transmit the data to be processed to the server, which then receives the data to be processed. During the transmission, the server may communicate with the client terminal via various networks (e.g., Wi-Fi wireless), data lines or other cable transmission modes.

At 104, the server may determine whether a random value corresponding to the data to be processed is stored in a storage medium associated with the server. If the random value corresponding to the data to be processed is stored in the storage medium associated with the server, operation 106 of the process 100 may be then executed. If the random value corresponding to the data to be processed is not stored in the storage medium associated with the server, operation 108 of the process 100 may be then executed.

After receiving data to be processed, the server may not process the data to be processed. The server may first determine whether a random value corresponding to the data to be processed is stored in the cache and/or other storage media associated with the server.

At 106, the server may process the data to be processed using the random value. For example, in response to a determination that the random value corresponding to the data to be processed is stored in the storage medium associated with the server, the server may determine that a random value for the data to be processed has been created. The server may then call the random value directly from the cache or other storage media associated with the server. Further, the server may process the data to be processed using the random value.

At 108, the server may obtain an additional random value for the data to be processed if the random value is not stored in the storage medium associated with the server. The server may process the data to be processed using the additional random value, and store the additional random value in the storage medium associated with the server.

In implementations, in response to a determination that the random value corresponding to the data to be processed is not stored, the server may determine that a random value for the data to be processed has not been created or the random value has been removed from the storage medium associated with the server. The server may obtain an additional random value for the data to be processed if the random value is not stored in the storage medium associated with the server. The server may then process the data to be processed using the additional random value, and store the additional random value in the storage medium associated with the server. Accordingly, when receiving the same data to be processed, the server will determine the random value corresponding to the order data.

Further, the server may preset a predetermined number of random values. The server may randomly select a preset random value from a predetermined number of random values as the random value corresponding to the data to be processed if the random value is not stored in the storage medium associated with the server.

In implementations, to conserve system resources, the server may store the random value corresponding to the data to be processed and monitor the length of storing time of the random value. In response to a determination that the length of storing time of the random value is greater than a predetermined threshold value, the server may remove the random value from the storage medium associated with the server. For example, the default length of storing time is 15 minutes.

Accordingly, the server may monitor the length of storing time of the random value after processing the data to be processed. In response to a determination that the length of storing time is greater than a predetermined threshold value, may remove the stored random value from the storage medium associated with the server.

The server may receive data to be processed, and further determine whether a random value corresponding to the data to be processed is stored in the storage medium associated with the server. In response to a determination that the random value is stored in the storage medium associated with the server, the server may process the data to be processed using the random value. If the random value is not stored in the storage medium associated with the server, the server may process the data to be processed using the additional random value, and process the data to be processed using the random value. The server may store the additional random value in the storage medium associated with the server. Because the random value is stored in the storage medium associated with the server, when receiving the data to be processed, the server determines whether the random value corresponding to the order data is stored in the storage medium associated with the server. In response to a determination that the random value is stored, the server may process the data to be processed without re-obtaining a random value. This effectively reduces loads on the server and saves system resources.

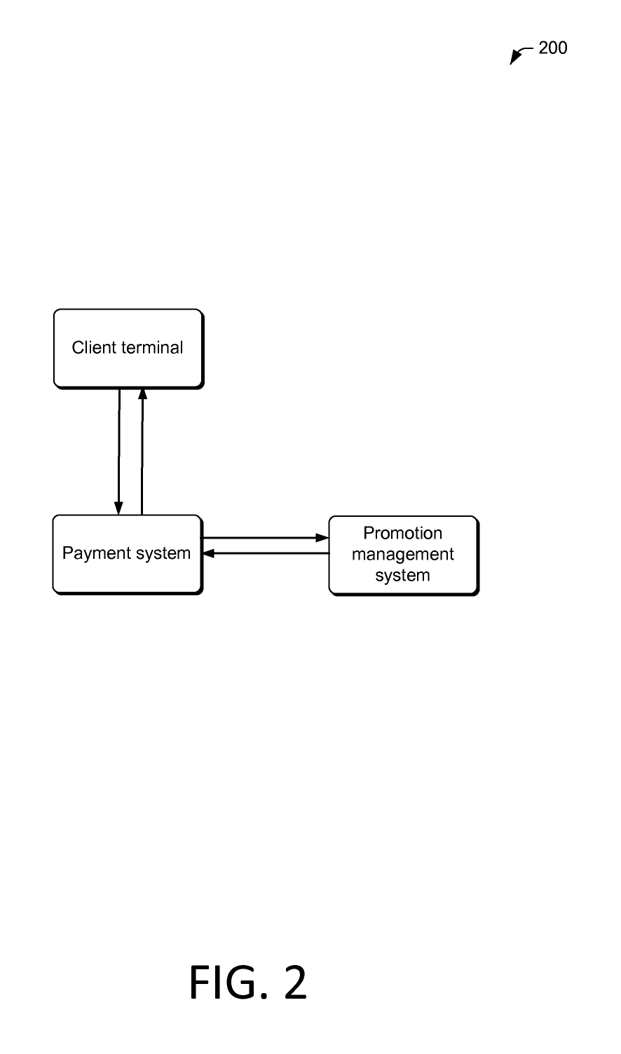

In a payment scenario, the data processing system in general is operated by a client terminal, a payment system, and a promotion management system. FIG. 2 is a schematic diagram of an illustrative computing environment 200 that enables data processing using a promotion management system. The client terminal of the promotion management system may transmit a payment request to the promotion management system via the payment system, and the payment request may include order data.

In these instances, the order data may include a buyer ID, a seller ID, an order amount, and/or an order ID. The order ID may be a string of letters, numbers and/or other characters, which correspond to the order data.

The promotion management system may determine whether a storage medium (e.g., a cache) associated with the promotion management system stores a random value (e.g., a discount amount) corresponding to the order ID contained in the order data. In response to a determination that the discount amount corresponding to the order data is stored, the promotion management system may determine that the discount amount has been assigned to the order data.

The promotion management system may directly return the discount amount to the payment system. The payment system may determine an actual amount of the order data based on the order amount and the discount amount. The payment system may return the actual amount to the client terminal, and a user associated with the client terminal may then make the payment based on the actual amount.

In response to a determination that the discount amount corresponding to the order data is not stored, the promotion management system may determine that the discount amount has not been assigned to the order data. The promotion management system may obtain a discount amount from the order data, and then return the discount amount to the payment system. The promotion management system may also store the discount amount corresponding to the order data in, for example a cache associated with the promotion management system.

The payment system may determine an actual amount of the order data based on the order amount and the discount amount. The payment system may return the actual amount to the client terminal, and a user associated with the client terminal may then make the payment based on the actual amount.

In some implementations, the promotion management system may preset a predetermined number of discount amounts. The promotion management system may randomly select a preset discount amount from the predetermined number of discount amounts as a discount amount corresponding to the order data if the discount amount is not stored in a storage medium associated with the promotion management system.

In implementations, information associated with the discount amounts may be stored in a cache of the promotion management system, or a cache and/or storage media associated with the payment system. The information may be stored in a separate storage media as long as the information may be accessed to determine whether a discount amount corresponding to the order data is stored.

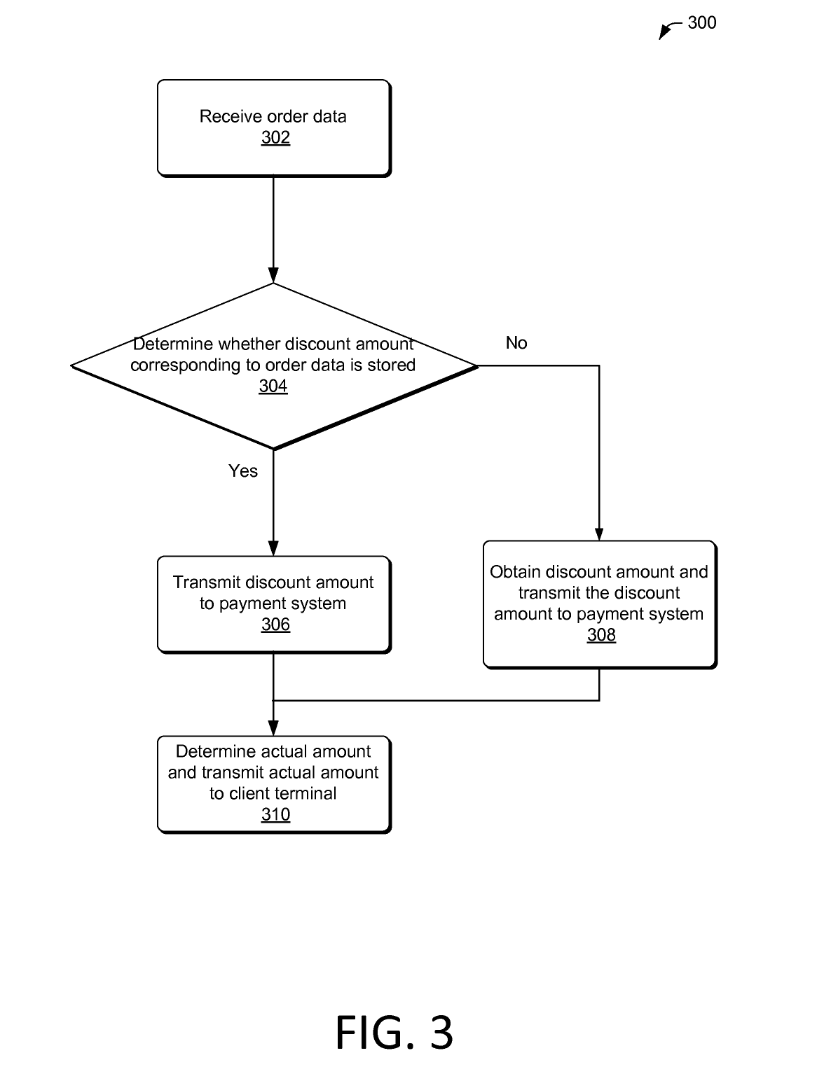

FIG. 3 is a flow chart of an illustrative process 300 for process data in a scenario of promotions. At 302, a client terminal of a promotion management system may transmit a payment request to the promotion management system via a payment system. The payment request may include order data.

At 304, the promotion management system may determine whether a discount amount corresponding to an order ID of the order data is stored. In response to a determination that the discount amount is stored in a storage medium associated with the promotion management system, operation 306 of the process 300 may be then executed. In response to a determination that the discount amount is not stored in the storage medium associated with the promotion management system, operation 308 of the process 300 may be then executed.

At 306, the promotion management system may directly transmit the discount amount to the payment system.

At 308, the promotion management system may obtain the discount amount from the order data. The promotion management system may then store the discount amount in the storage medium associated with the promotion management system and transmit the discount amount to the payment system.

At 310, the payment system may transmit the actual amount to the client terminal, and a user associated with the client terminal may then make the payment based on the actual amount.

The following examples illustrate specific data processing steps. Suppose that there are three discount amounts (e.g., random values) for a promotion. The discount amounts include 10, 20, and 50 yuan and are available for qualified orders. Further suppose that order A is qualified and order data of the order A (e.g., “order data a”) includes a discount amount (e.g., 100 yuan) and an order ID (e.g., 888).

The client terminal of the promotion management system may transmit a payment request to the promotion management system via the payment system, and the payment request may include “order data a”. Further, the promotion management system may determine whether a discount amount corresponding to “order 888” of the order data is stored.

The promotion management system may determine that the discount amount of 10 yuan corresponding to “order 888” is stored, and then return the discount amount to the payment system. The payment system may determine an actual amount (e.g., 90 yuan) of the order data based on the order amount and the discount amount. The payment system may return the actual amount to the client terminal, and a user associated with the client terminal may then make the payment based on the actual amount.

In response to a determination that the discount amount corresponding to “order 888” is not stored, the promotion management system may determine that the discount amount has not been assigned to the order data. The promotion management system may obtain the discount amount of 10 yuan from the order data, and then return the discount amount to the payment system. The promotion management system may also store the discount amount (i.e., 10 yuan) corresponding to the order data in for example, a cache of the promotion management system.

The payment system may return the actual amount (i.e., 90 yuan) to the client terminal, and a user associated with the client terminal may then make the payment based on the actual amount.

When receiving an additional order data, the promotion management system may determine whether a discount amount corresponding to an order ID of the order data is stored without randomly selected once again.

Further, to save system resources, the promotion management system may store the discount amount corresponding to the order ID in a cache and/or storage media associated with the promotion management system.

In response to a determination that the length of storing time of the random value is greater than a predetermined threshold value, the promotion management system may remove the discount amount from the cache and/or storage media of the promotion management system. For example, the default length of storing time may be set as 15 minutes. In these instances, the promotion management system may monitor the length of storing time of a discount amount after storing the discount amount. In response to a determination that the length of storing time is greater than a predetermined threshold value, the promotion management system may remove the stored random value from the storage medium associated with the promotion management system.

In implementations, users may purposefully cause multiple payments failed and send multiple order requests of the same order to obtain an ideal discount amount. This may increase server loads. To prevent this, the length of storing time for a discount amount may be set relatively longer than a normal time period, such as 48 hours. In some instances, long storing times may occupy a large amount of system resources. To save system resources, the length of storing time may be short. In some implementations, the length of storing time may be adjusted dynamically in response to, for example, user behavior with respect to payments.

In implementations, when receiving an order data, the promotion management system may determine that a discount amount corresponding to an order ID of the order data is stored. The promotion management system may reset the length of storing time for the discount amount. For example, the promotion management system may reset the length of storing time as zero and restart to record the length of storing time for the discount amount.

Suppose that a length of storing time of a discount amount is about 1 hour. At 10:00 AM on May 20, 2014, the client terminal of the promotion management system may transmit a payment request to the promotion management system via the payment system, and the payment request may include “order data a”. In response to a determination that the discount amount (e.g., 10 yuan) corresponding to “order 888” is stored, the promotion management system may monitor a length of storing time of the discount amount.

If the user is not satisfied with the discount amount, the user may cause the payment to be failed. Suppose that in 10 minutes (e.g., at 10:10 AM on May 20, 2014) after receiving the order request, the promotion management system receives an additional order request of “order data a”. The promotion management system may determine that the discount amount (i.e., 10 yuan) corresponding to “order 888” is stored, and then return the discount amount to the payment system. The payment system may process the order request using the discount amount.

At the same time, the promotion management system may set the length of storing time (i.e., 10 minutes) as zero and then start to record the length of storing time of the discount amount. Accordingly, within 1 hour after 10:10 AM on May 20, 2015, the discount amount (i.e., 10 yuan) may be determined and stored in a cache and/or storage media associated with the promotion management system in response to a determination that the promotion management system receive an additional order request containing “order data a.”

In response to a determination that the discount amount is stored, the promotion management system may reset the length of storing time. Therefore, the length of storing time is extended.

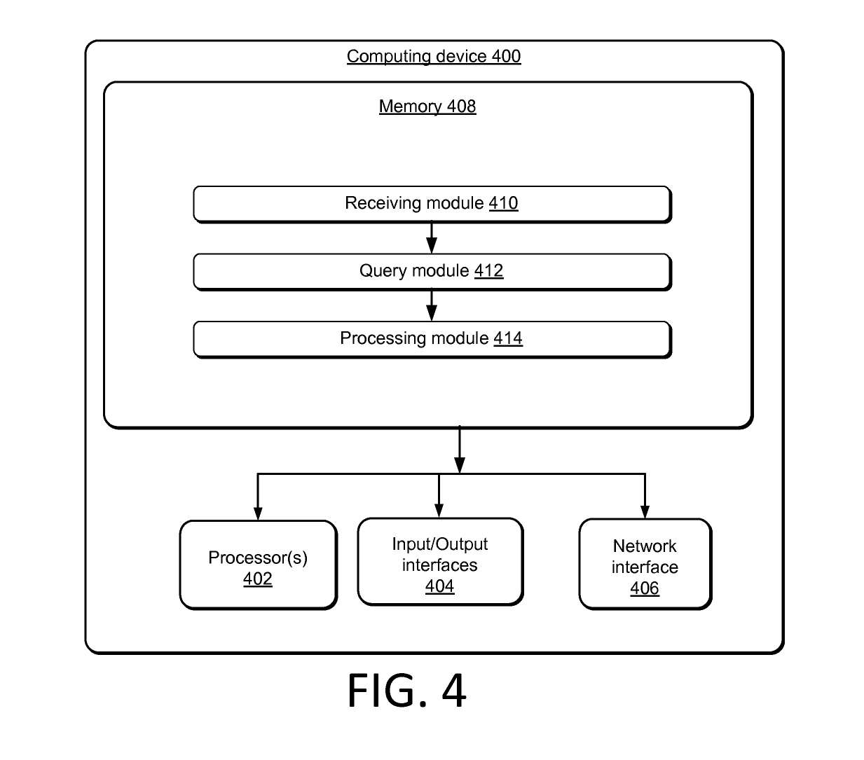

FIG. 4 is a schematic diagram of an illustrative computing architecture 400 that enables data processing. The computing device 400 may be a user device or a server for data processing. In an exemplary configuration, the computing device 400 includes one or more processors 402, input/output interfaces 404, network interface 406, and memory 408.

The memory 408 may include computer-readable media in the form of volatile memory, such as random-access memory (RAM) and/or non-volatile memory, such as read only memory (ROM) or flash RAM. The memory 408 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 408 in more detail, the memory 408 may include a receiving module 410, a query module 412, and a processing module 414. The receiving module 410 may be configured to receive data to be processed. The query module 412 may be configured to determine whether a random value corresponding to the data to be processed is stored in a storage medium associated with the computing device 400. The processing module 414 may be configured to, in response to a determination that a random value corresponding to the data to be processed is stored in the storage medium associated with the computing device 400, process the data to be processed without re-obtaining a random value. In response to a determination that a random value corresponding to the data to be processed is not stored in the storage medium associated with the computing device 400, the processing module 414 may obtain an additional random value based on the data to be processed. The processing module 414 may process the data to be processed using the additional random value, and store the additional random value in the storage medium associated with the computing device 400.

In implementations, the receiving module 410 may receive order data, and the query module 412 may determine whether an order ID of the order data corresponds to the stored random value.

In implementations, the processing module 414 may randomly select a preset random value among the predetermined number of random values as the additional random value corresponding to the data to be processed.

In implementations, the processing module 414 may monitor a length of storing time of the random value. In response to a determination that the length of storing time is greater than a predetermined threshold value, the processing module 414 may remove the stored random value from the storage medium associated with the computing device 400.

In implementations, the processing module 414 may reset the length of storing time of the random value in response to a determination that the random value corresponding to the data to be processed is stored in the storage medium associated with the computing device 400.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A method implemented by one or more computing devices, the method comprising:
receiving data to be processed;
determining whether a first random value corresponding to the data to be processed is stored in a storage medium associated with the one or more computing devices;
performing a corresponding operation on the data to be processed based at least in part on a determination result of whether the first random value corresponding to the data to be processed is stored in the storage medium associated with the one or more computing devices, the corresponding operation comprising one of processing the data to be processed using the first random value or processing the data to be processed using a second random value.

2. The method of claim 1, further comprising processing the data to be processed using the first random value in response to determining that the first random value corresponding to the data to be processed is stored in the storage medium associated with the one or more computing devices.

3. The method of claim 1, further comprising processing the data to be processed using the second random value in response to determining that the first random value corresponding to the data to be processed is not stored in the storage medium associated with the one or more computing devices.

4. The method of claim 3, further comprising:
obtaining the second random value for the data to be processed; and
storing the second random value in the storage medium associated with the one or more computing devices.

5. The method of claim 4, wherein obtaining the second random value for the data to be processed comprises:
presetting a predetermined number of preset random values;
randomly selecting a preset random value from the predetermined number of preset random values; and
designating the selected preset random value as the second random value for the data to be processed.

6. The method of claim 1, wherein the data to be processed comprises order data, and wherein determining whether the first random value corresponding to the data to be processed is stored in the storage medium associated with the one or more computing devices comprises determining whether an order identifier (ID) of the order data corresponds to the first random value is stored in the storage medium associated with the one or more computing devices.

7. The method of claim 1, further comprising:
monitoring a length of storing time of the first random value or the second random value; and
in response to a determination that the length of storing time is greater than a predetermined threshold value, removing the first random value or the second random value from the storage medium associated with the one or more computing devices.

8. The method of claim 7, further comprising:
resetting the length of storing time of the first random value in response to the determination that the first random value corresponding to the data to be processed is stored in the storage medium associated with the one or more computing devices.

9. A system comprising:
one or more processors; and
memory to maintain a plurality of components executable by the one or more processors, the plurality of components comprising:
a receiving module configured to receive data to be processed,
a query module configured to determine whether a corresponding random value for the data to be processed is stored in a storage medium associated with the system, and
a processing module configured to:
process the data to be processed using the corresponding random value in response to a determination that the corresponding random value for the data to be processed is stored in the storage medium associated with the system,
in response to a determination that the corresponding random value for the data to be processed is not stored in the storage medium associated with the system:
obtain an additional random value for the data to be processed,
process the data to be processed using the additional random value, and
store the additional random value in the storage medium associated with the system.

10. The system of claim 9, wherein the receiving module is configured further to receive order data, and wherein the query module is further configured to determine whether an order ID of the order data corresponds to the corresponding random value is stored in the storage medium associated with the system.

11. The system of claim 9, wherein the processing module is configured further to:
preset a predetermined number of preset random values;
randomly select a preset random value among the predetermined number of preset random values; and
designate the selected preset random value as the additional random value corresponding to the order data.

12. The system of claim 9, wherein the processing module is configured further to:
monitor a length of storing time of the corresponding random value; and
remove the corresponding random value from the storage medium associated with the system in response to the determination that the length of storing time is greater than a predetermined threshold value.

13. The system of claim 9, wherein the processing module is configured further to reset the length of storing time of the corresponding random value in response to the determination that the corresponding random value for the data to be processed is stored in the storage medium associated with the system.

14. One or more computer-readable media storing computer-executable instructions that, when executed by one or more computing devices, instruct the one or more computing devices to perform acts comprising:
determining whether a first random value corresponding to the data to be processed is stored in a storage medium associated with the one or more computing devices;
performing a corresponding operation on the data to be processed based at least in part on a determination result of whether the first random value corresponding to the data to be processed is stored in the storage medium associated with the one or more computing devices, the corresponding operation comprising one of processing the data to be processed using the first random value or processing the data to be processed using a second random value.

15. The one or more computer-readable media of claim 14, wherein the acts further comprise processing the data to be processed using the first random value in response to determining that the first random value corresponding to the data to be processed is stored in the storage medium associated with the one or more computing devices.

16. The one or more computer-readable media of claim 14, wherein the acts further comprise processing the data to be processed using the second random value in response to determining that the first random value corresponding to the data to be processed is not stored in the storage medium associated with the one or more computing devices.

17. The one or more computer-readable media of claim 16, wherein the acts further comprise:
obtaining the second random value for the data to be processed; and
storing the second random value in the storage medium associated with the one or more computing devices.

18. The one or more computer-readable media of claim 17, wherein obtaining the second random value for the data to be processed comprises:
presetting a predetermined number of preset random values;
randomly selecting a preset random value from the predetermined number of preset random values; and
designating the selected preset random value as the second random value for the data to be processed.

19. The one or more computer-readable media of claim 14, wherein the acts further comprise:
monitoring a length of storing time of the first random value or the second random value; and
in response to a determination that the length of storing time is greater than a predetermined threshold value, removing the first random value or the second random value from the storage medium associated with the one or more computing devices.

20. The one or more computer-readable media of claim 14, wherein the acts further comprise resetting the length of storing time of the first random value in response to the determination that the first random value corresponding to the data to be processed is stored in the storage medium associated with the one or more computing devices.
